(19) United States
(12) Patent Application Publication
(10) Pub. No.: US 2010/0004352 A1
(43) Pub. Date: Jan. 7, 2010

(54) Method for the production of curable masses, containing coarse-scale and/or nanoscale, coated, de-agglomerated and preferably functionalized magnesium hydroxide particles, as well as of cured composites, containing de-agglomerated and homogenously distributed magnesium hydroxide filler particles

(76) Inventors: David Christopher Glende, Bovenden (DE); Ingo Stahl, Vellmar (DE); Stefan Dressel, Kassel (DE)

Correspondence Address: COLLARD & ROE, P.C., 1077 NORTHERN BOULEVARD, ROSLYN, NY, 11576, US

(21) Appl. No.: 12/459,548

(22) Filed: Jul. 2, 2009

(30) Foreign Application Priority Data
Jul. 4, 2008 (DE) 10 2008 031 360.2

(51) Int. Cl. C08K 3/22; C09K 3/00

(52) U.S. Cl. 523/200; 252/182.32

(57) ABSTRACT

The present invention relates to a method for the production of curable masses, containing coarse-scale and/or nanoscale, coated, de-agglomerated magnesium hydroxide particles. More precisely, the present invention relates to a method for the production of curable masses, whereby coarse-scale and/or nanoscale, precoated magnesium hydroxide particles in an aqueous or organic solvent are treated with ultrasound or subjected to bead-mill grinding in the presence of a dispersant. After any drying that might be necessary, and renewed suspension/dispersion in an organic solvent, the magnesium hydroxide particles are worked into a component of a curable mass. Furthermore, the present invention is directed at a method for the production of a cured polymer material. Finally, the present invention makes available curable masses, polymer materials produced from them, particularly duroplastics or thermoplastics, as well as composite material containing curable masses or polymer materials produced according to the invention, as well as reinforcement agents.

The present invention relates to a method for the production of curable masses, containing coarse-scale and/or nanoscale, coated, de-agglomerated and homogeneously distributed magnesium hydroxide particles. Also, the present invention relates to a method for processing coarse-scale and/or nanoscale, preferably precoated magnesium hydroxide particles as a suspension or dispersion in an aqueous solvent, which can also be present in dried form, if necessary. Also, after drying of the suspension or dispersion and renewed resuspension/dispersion in an organic solvent, with the addition of a dispersant D, de-agglomeration can follow in a second method step, by means of a bead mill or ultrasound treatment. Subsequently the dispersions that are produced can be worked into a component of a curable mass, in aqueous or organic solvent. Furthermore, the present invention is directed at a method for the production of a curable polymer material. Finally, the present invention makes available curable masses, polymer materials produced from them, particularly duroplastics or thermoplastics, as well as composite material containing curable masses or polymer materials produced according to the invention, in combination with reinforcement agents.

### STATE OF THE ART

It is generally known that fillers are introduced into plastics to modify their properties. These fillers can be both coarse-scale and nanoscale in terms of their particle size, and are usually present as dried powders.

Composite materials in an epoxy resin matrix can be used, for example, in aircraft construction, in space travel—for example for satellites—, for vehicle construction, in ship construction, for building construction, in railroad construction, for flywheels, and for pressurized vessels. Such possibilities are described as examples in the U.S. patent application 2003/0064228 and in EP 1 094 087. Other examples of composite materials for rotors for wind power plants are explained in Kunststoffe [Plastics], Issue 11 (2002), pages 119-124.

Nanoscale barium sulfates are described in WO 2005/054357. These are introduced into epoxy resins in the de-agglomerated state, and allow an improvement in the impact bending resistance and the elongation to fracture. The nanoparticles described in this application, on the basis of barium sulfate, are modified with a polyether carboxylate that has terminal hydroxyl groups for a reaction with the epoxy resin. These are disadvantageous for the reaction with the epoxy resin, since the aforementioned hydroxyl groups are slow to react with the epoxy groups of the resin, and thus coupling of the nanoparticles to the epoxy resin takes place only to a limited extent.

The epoxy resins described in WO 2005/054357 are used, for example, as light construction materials in wind power plants, pipes, containers, etc. However, the functional groups mentioned in the document do not allow complete binding of the fillers to the resins. Furthermore, there is a need to make available improved compound materials, which allow increased elongation to fracture and impact bending resistance while simultaneously increasing the modulus of elasticity.

Finally, there is a permanent need for ever lighter materials for the production of corresponding materials, whereby it should be possible to produce these as cost-advantageously as possible.

In WO 2005/054357, the barium sulfate that is described is used either in dried form or as an aqueous suspension. In order to be worked into resins from which duroplastic or thermoplastic materials are formed, the mixtures of dried and ground filler were mixed with the resin or hardener, and homogenized, by means of an intensive stirrer or an Ultraturrax, and subsequently polymerized by means of adding the other component, in each instance. In the case of such thermoplastic or duroplastic materials, in which the nanoscale dried filler in powder form is intensively mixed with the resin by means of a dissolver or an Ultraturrax, only a fraction of the agglomerates of the barium sulfate agglomerates can be destroyed. In both of the cases described, the shear forces that are introduced are not sufficient for complete de-agglomeration of the nanoscale fillers.

As a result, after curing, polymer materials are obtained that contain agglomerated nanoparticles in the micrometer range, having the mechanical property profile of coarse-scale fillers.

Magnesium hydroxide and aluminum trihydroxide are used in various polymers as halogen-free mineral flame protection agents. These fillers are used in polymers in coarse-scale form, at filler contents of at least 50 wt.-%. At a filler content of at least 50 wt.-%, for example at contents of 55 to 65 wt.-%, it is possible to achieve the fire protection class Vo according to the fire protection test UL94 developed by Underwriter Laboratory in the USA, depending on the polymer—however, the mechanical properties of the plastic clearly suffer from the high inorganic filler content. Frequently, the plastic becomes brittle; this is connected with a lower impact resistance and lower values for elongation to tear.

There are already many publications concerning the topic of “nanoscale magnesium hydroxide as a flame protection agent in polymers.” For example, WO 99/08962 describes wet grinding of a magnesium hydroxide slurry, with the addition of cationic polymers as a dispersant. However, in the case of this method, neither adaptation of the polarity of the particles to the polymer target matrix for subsequent better working into polymers, nor functionalization of the particles for optimization of the mechanical properties is disclosed. Also, the content of dispersant described in this document is very low.

In US 2004/074361, coating of coarse-scale magnesium hydroxide agglomerates with additives that are partly reactive, such as functionalized silanes, is described. Here, too, a dry and thus agglomerate powder of magnesium hydroxide is used as the starting substance, so that here, too, only the agglomerates are coated. Finally, WO 2002/081574 describes coating of magnesium hydroxide powder in a Henschel mixer, with aminosilanes, titanates, zirconates, and fatty acids, and their subsequent introduction into polyamides. However, in the case of this method, only agglomerates are coated, not primary particles, and the subsequent introduction into polymers does not take place in de-agglomerated form.

All the documents mentioned in the state of the art describe working in agglomerated magnesium hydroxide particles that consist of coarse-scale and/or nanoscale primary particles. It is true that they are referred to as nanoscale and are used as fillers, but these are necessarily present agglomerated on the micrometer scale, as a result of the drying process, so that the mechanical properties of the filled polymer are similar to those of a plastic filled with coarse-scale magnesium hydroxide. The drying step brings about an agglomeration of the nanoscale particles, which cannot be completely de-agglomerated later, as the result of mechanical processing with an Ultraturrax or a dissolver, for example. For such applications and materials, as well, it is desirable to make available a method for the production of polymer materials that guarantee not only an increased elongation to fracture and impact bending resistance, but also a simultaneous increase in the modulus of elasticity.

The present invention is based on the task of making methods available that yield coarse-scale and/or nanoscale, de-agglomerated and if necessary functionalized and homogeneously distributed magnesium hydroxide particles containing curable masses, and/or curable masses. Only in this way is the production of coarse-scale and/or nanoscale, de-agglomerated polymer materials having a significantly improved mechanical property profile made possible.

Another task of the present invention is to make available such de-agglomerated filled curable masses as a precursor of polymer materials, as well as to make available such polymer materials, particularly duroplastics or thermoplastics, themselves.

Finally, another task of the present invention is to make available composite materials containing such de-agglomerated filled polymer materials in combination with reinforcement agents, such as glass fibers, carbon fibers, or Kevlar fibers, for example.

The aforementioned polymer materials are characterized by an improvement in the mechanical properties because of improved particle distribution and the improved binding of the fillers in the polymer.

### DETAILED DESCRIPTION OF THE INVENTION

It was surprisingly found that magnesium hydroxide in coarse-scale and/or nanoscale, coated, de-agglomerated form meets the above requirements. Particularly in connection with this new method for introducing the magnesium hydroxide into the curable mass as a filler, it is possible to make available polymer materials having improved mechanical properties.

In a first aspect, the present invention is directed at a method for the production of curable masses, containing coarse-scale and/or nanoscale, coated, de-agglomerated and if necessary functionalized magnesium hydroxide particles, comprising the steps
a) making available coarse-scale and/or nanoscale, non-coated or precoated magnesium hydroxide particles in dried form,
b) suspending or dispersing the magnesium hydroxide particles in an organic solvent,
c1) treating the suspension or dispersion with ultrasound in the presence of a dispersant D, or alternatively,
c2) bead-mill grinding of the suspension or dispersion in the presence of a dispersant D,
d1) mixing the dispersion obtained in step c1), containing de-agglomerated, coarse-scale and/or nanoscale, multiply coated and if necessary functionalized magnesium hydroxide particles with a component of a curable mass, or alternatively,
d2) mixing the dispersion obtained in step c2), containing de-agglomerated, coarse-scale and/or nanoscale, simply or multiply coated and if necessary functionalized magnesium hydroxide particles with a component of a curable mass,
e) curing the curable mass by means of adding a suitable component.

In a second aspect, the present invention is directed at a method for the production of filled polymer dispersions, containing coarse-scale and/or nanoscale, coated, de-agglomerated and if necessary magnesium hydroxide particles, comprising the steps
a) making available coarse-scale or nanoscale, preferably precoated magnesium hydroxide particles as a suspension or dispersion in an aqueous solvent containing dispersant B or in dried form;
b) if necessary, dispersing or suspending the magnesium hydroxide particles in dried form in an aqueous solvent,
c1) bead-mill grinding of the suspension or dispersion in the presence of a dispersant B, or alternatively,
c2) treating the suspension or dispersion with ultrasound in the presence of dispersant B,
d1) mixing the dispersion obtained in step c1), containing de-agglomerated, coarse-scale and/or nanoscale, simply or multiply coated and if necessary functionalized magnesium hydroxide particles with an aqueous polymer dispersion,
d2) mixing the dispersion obtained in step c2), containing de-agglomerated, coarse-scale and/or nanoscale, multiply coated and if necessary functionalized magnesium hydroxide particles, with an aqueous polymer dispersion,
e) forming the polymer from the polymer dispersion obtained in this way, in step d1) and d2).

The magnesium hydroxide particle dispersions that were produced according to method step c1) or c2) demonstrate a solids content of 20-70 wt.-% of magnesium hydroxide.

The term “de-agglomerated” as used here means that the secondary particles are not present in a form in which they have been completely broken down into primary particles, but rather these are present in clearly less agglomerated or aggregated form than after a drying step of non-coated primary particles. Because every primary particle is present in coated form, complete de-agglomeration is more easily possible.

In the present case, the term “coarse-scale” is understood to mean a particle size distribution such that the average particle diameter (d50) is greater than 100 nm. In other words, particles having a particle diameter greater than 100 nm by more than 50%, such as more than 70%, 80%, particularly more than 90%, such as 95% and particularly 98%, are referred to as coarse-scale particles.

“Nanoscale” refers to particle size distributions whose average particle diameter (d50) is <100 nm. In other words, particles having a particle diameter <100 by more than 50%, such as more than 70%, 80%, particularly more than 90%, such as 95% and particularly 98%, are referred to as nanoscale particles.

The coarse-scale and/or nanoscale, precoated magnesium hydroxide particles made available in step a) are obtained, in this connection, in that a magnesium salt solution is brought into contact with an alkali hydroxide solution, forming a reaction mixture for precipitating coated magnesium hydroxide primary particles, whereby at least one of the additives A, B and/or C is contained in at least one—the magnesium salt solution or alkali hydroxide solution—or when one of the two solutions is brought into contact, at least one of the additives A, B and/or C that is/are present is simultaneously brought into contact with the reaction mixture that results from the two solutions, whereby the additives are a growth inhibitor A, a dispersant B and/or in the aqueous fatty acid solution C or mixtures thereof. Afterwards, the production of precoated magnesium hydroxide particles is possible, whereby the magnesium hydroxide particles are characterized in that every individual one of the magnesium hydroxide primary particles is completely coated, since a coating on the surface of every individual primary particle is already formed during the precipitation process, due to the presence of the aforementioned additives. These coarse-scale and/or nanoscale, coated, de-agglomerated magnesium hydroxide particles can be made available in dried form or in the form of a suspension/dispersion, as the starting material.

Subsequently, as a de-agglomeration process, treatment by means of a bead mill or ultrasound is carried out, during which each particle is given its own, if necessary additional surface coating by means of adding suitable additives or additive mixtures. This bead-mill grinding or ultrasound treatment takes place, in this connection, in a solvent and with the addition of a suitable dispersant. When using an organic solvent, a dispersant D is used, while when using an aqueous solvent, a dispersant B is used. The coarse-scale and/or nanoscale particles of magnesium hydroxide that are formed during the de-agglomeration process by means of the bead mill or ultrasound are electrostatically and/or sterically stabilized by means of the addition of dispersant B in the case of an aqueous solvent, or dispersant D in the case of an organic solvent, and thus protected against re-agglomeration. The polarity of the particles is also adapted to the subsequent polymer target matrix by means of suitable dispersants B or dispersants D, the coatings. Thus, subsequent working in into the polymers is facilitated. The coating also acts as a spacer (spacer), since the crystal surfaces of the coarse-scale and/or nanoscale particles cannot touch and the nanoscale particles are prevented from growing together to form larger aggregates. Thus, the formation of solid aggregates is prevented. Also, the dispersants B and dispersants D added during the de-agglomeration steps can already carry functional groups that can later covalently bind the coarse-scale or nanoscale particles to the polymer target matrix, in order to allow a significant improvement in the mechanical properties of the polymer active substances.

A significant aspect of the method according to the invention, in this connection, is that the coarse-scale and/or nanoscale, coated, de-agglomerated and functionalized magnesium hydroxide particles are used not as a dried powder, in which these particles are present in agglomerated form, but rather as de-agglomerated, coated and functionalized particles, preferably individual primary particles, as a suspension or dispersion. For the production of the polymer active substances, particularly the thermoplastics or duroplastics, this suspension or dispersion is mixed with the monomers, oligomers, or, alternatively, with the hardener, and subsequently polymerized by means of adding the hardener or the monomers/oligomers (resin component) and the additional additives.

Another advantage of the present method is that during the subsequent comminution process described below, by means of bead-mill grinding or ultrasound, the starting material used is not conventional, commercially available magnesium hydroxide, but rather precoated material, as explained above. This precoated magnesium hydroxide has the advantage, as compared with conventional material, that during the comminution processes by means of bead-mill grinding or ultrasound, only loose agglomerates of primary particles have to be de-agglomerated, since these primary particles that have been obtained are already completely coated by means of the in situ method for the production of the magnesium hydroxide particles described above, and thus firm aggregation and growing-together of the crystal surfaces was already prevented during precipitation. In the case of conventional material as the starting material, on the other hand, the processes involved are in fact mechanical comminution processes, in which the aggregates have to be broken up. This clearly requires more energy and is more time-consuming. Also, clearly lower particle sized distributions can be achieved with precoated material, by means of bead-mill grinding or ultrasound. Comminuting conventional material by means of ultrasound requires a great amount of energy and would not guarantee the advantages of the use of the ultrasound treatment according to the invention.

The magnesium hydroxide used as the starting material demonstrates a clearly lower density in comparison with barium sulfate, as it is used in the state of the art. Thus, significantly lighter composite materials can be produced as finished components. Such light construction materials on a polymer basis find use in different sectors, such as in aircraft, vehicle, or rail construction. Furthermore, the starting materials for the production of the magnesium hydroxide nanoparticles are more cost-advantageous in comparison with barium sulfate particles, and thus allow the production of more cost-advantageous end products. As compared with barium sulfate, the use of magnesium hydroxide has the additional advantage that the nanoparticles can give off their water of crystallization particularly quickly in case of a fire, because of the enclosed water of crystallization and because of their large surface area, and thus cooling of the polymer occurs rapidly, and afterwards, a protective oxide layer can form. As a result, the polymer materials according to the invention are particularly suitable also as fire protection agents. As another advantage of the method according to the invention, it should be mentioned that when using sterically stabilizing additives, particularly functionalized additives, these simplify coupling of the magnesium hydroxide particles with the hardener or the resin. Thus, complete binding of the nanoparticles with the polymer matrix is made possible in the first place.

Finally, the economic aspect must be taken into consideration. Particularly by means of the use of ultrasound, cost-advantageous production of nanoscale filled curable masses and thus of polymer materials as well as composite materials can be achieved on a large scale.

As has been stated, the coarse-scale or nanoscale magnesium hydroxide produced according to the method described above can be used as a starting material, where the primary particles can demonstrate a precoating (precoating) with a growth inhibitor A, the dispersant B and/or the aqueous stearate solution C. As a function of the additive used, the suspension or dispersion obtained in the first method step—the in situ precipitation—can be directly subjected to a second method step—the bead-mill grinding or the ultrasound treatment—in which coarse-scale or nanoscale, coated and if necessary functionalized aqueous dispersions are formed. Also, after the first method step, a drying process can be carried out, if the work is to continue in an organic solvent. This drying can be carried out by means of spray-drying, for example. If the precoated magnesium hydroxide produced in this manner is spray-dried, an agglomerated coarse-scale or nanoscale magnesium hydroxide powder is formed, which is accordingly coated with the growth inhibitor A, the dispersant B and/or the aqueous stearate solution C.

This powder can be de-agglomerated in an aqueous or organic solvent, by means of a bead mill or treatment with ultrasound, using suitable sterically stabilizing dispersants B or dispersants D, respectively. As a result, nanoscale magnesium hydroxide dispersions in either aqueous or organic solvents, which are stable in storage, are obtained. These dispersions can then be worked into the component(s) of the curable mass, such as monomers/oligomers (resin) or the hardener, from which the polymer materials, particularly the thermoplastics or duroplastics, can then be produced.

The dispersant B has one or more anionic groups in its molecule. It can be present, for example, in low-molecular, monomer, oligomer form, or as a polymer. The dispersant B can also be used as a salt of this compound, whereby the main chain, containing with one or more anionic groups, can also be branched or cyclic, with hydrophobic and/or hydrophilic structures. These anionic groups, for example carboxy, phosphonate, phosphate, sulfonate or sulfate groups, bring about anionic coupling of the additive molecule on the filler surface, since they can enter into interaction with the magnesium hydroxide surface. The additionally present oligomer or polymer main chains, and, if applicable, additional side chains that are present allow further electrostatic and/or steric stabilization and thus prevent re-agglomeration. The side chains can consist of semi-polar and/or hydrophilic structures. In addition, they impart an external polarity to the particles, which makes the particle appear more hydrophilic or more hydrophobic, depending on the dispersant B, and, by means of this adaptation of the polarity, allows easier introduction into a polymer matrix later, and prevents agglomeration in the polymer, so that the magnesium hydroxide particles, after having been worked in, are present in de-agglomerated form and homogeneously distributed in the polymer matrix. Also, these dispersants B for aqueous solvents can contain additional reactive end groups, and thus be functionalized. These functionalized groups comprise hydroxyl groups, but also double bonds, amine and thiol groups. Using these functional groups, covalent linking with the components of the polymer can subsequently take place, for example OH groups with a diisocyanate, with the formation of a polyurethane.

The dispersant B demonstrates good water solubility, since according to the invention, it is either present in the reaction mixture for the production of the magnesium hydroxide particles, or is added to the aqueous suspension or dispersion of the magnesium hydroxide particles in the aqueous solvent.

The amount of the dispersant B can vary. Usually, the dispersant B is present in a concentration of 0.1 to 20 wt.-% with reference to the solids content of Mg(OH)₂.

Suitable dispersants B that can be used in aqueous solvents comprise polyacrylates such as Sokalan® PA (BASF), for example, polyether carboxylates, such as Melpers® 0030 (BASF), for example, phosphoric acid esters, such as Disperbyk® 102 (Byk-Chemie), for example, or polyphosphates, such as Calgon® N or high-molecular polymers with filler-affinic groups, for example present as block copolymers, such as Disperbyk® 190, for example.

In the case of organic solvents, the dispersant D is used. The dispersant D can be present in low-molecular, monomer, oligomer form, or as a polymer. This dispersant D for organic solvents, like dispersant B, has one or more anionic groups, such as sulfonate, sulfate, phosphonate, phosphate or carboxy groups. They allow the corresponding interaction with the surface of the magnesium hydroxide particles and allow stabilizing the resulting particles electrostatically and/or sterically, and thus prevent re-agglomeration.

These stabilizing dispersants D can contain main chains and, if applicable, additional oligomer or polymer side chains, which for one thing allow steric stabilization and, for another, can carry one or more end groups that are able to interact with the target polymer and, if necessary, can enter into covalent bonds with the target polymer. These reactive end groups, also called functionalization, are, for example, double bonds, hydroxy, amine, thiol, diisocyanate or epoxy groups.

The dispersant D can be present in low-molecular, monomer, oligomer form or as a polymer. The side chains can consist of hydrophobic and/or hydrophilic structures.

The sterically stabilizing dispersant D is used in concentrations of 0.1 to 20 wt.-% with reference to the solids content of Mg(OH)₂.

Examples of dispersant D are phosphoric acid esters—for example Disperbyk® 106 (Byk-Chemie), silanes, for example Glymo® (Degussa), and titanates, for example Ken-react CP-03® (Kenrich Petrochemicals). But the polyether carboxylate Melpers® 0030® (BASF) mentioned as dispersant B can also be used as dispersant D, since Melpers® 0030 is also soluble in organic solvents, such as n-butanol, for example.

In a first embodiment of the method for the production of curable masses, the coarse-scale and/or nanoscale, precoated magnesium hydroxide particles are used in dried form, i.e. in powder form, if the work is to continue in an organic solvent. However, for aqueous systems, for example, the suspensions or dispersions obtained directly in the precipitation reaction can also be used. These might also contain the growth inhibitor A, as explained further below, the dispersant B and/or the aqueous stearate solution C.

Preferred organic solvents that can be used according to the invention in all of the methods, are, for example, ethanol, isopropanol, butanol, methyl ethyl ketone, acetone, ethyl acetate, cyclohexane, hexane or boiling point benzene. Subsequently, this suspension or dispersion is treated with ultrasound in the presence of the aforementioned dispersant B or D. Alternatively, treatment by means of bead-mill grinding of the suspension or dispersion can take place in the presence of a dispersant B or D. In this way, a dispersion in an aqueous or organic solvent, containing de-agglomerated, coarse-scale and/or nanoscale, multiply coated and if necessary functionalized magnesium hydroxide particles, coated with the dispersant B or dispersant D, is obtained. This dispersion is mixed, as such, with a component of the curable mass, for example resin or hardener, by means of known methods.

Subsequently, the aqueous or organic solvent can be removed from the mixture of a component of the curable mass and the dispersion containing de-agglomerated, coarse-scale and/or nanoscale, multiply coated and functionalized magnesium hydroxide particles. This removal can take place with usual means, such as, for example, under vacuum. The solvent can be drawn off by means of a rotation evaporator, for example.

In a second embodiment, the coarse-scale and/or nanoscale, precoated magnesium hydroxide obtained from the first method step, the in situ precipitation, is made available as the starting material as a suspension or dispersion in an aqueous dispersant, or in dried form. Preferably, the starting material is the precoated product that was obtained directly after the precipitation reaction, in other words the reaction mixture containing dispersant B and, if applicable, further containing the growth inhibitor A. This growth inhibitor A is one as described in the state of the art, for example, in DE 103 57 116 A1.

This suspension or dispersion that is obtained from the in situ precipitation can be subjected directly to treatment with ultrasound or bead-mill grinding; if necessary, additional dispersant B is added in order to achieve the desired properties of the magnesium hydroxide particles and to prevent re-agglomeration.

Of course, the coated primary particles produced with growth inhibitor A and/or dispersant B can also be dried first, and then be used in the methods according to the invention as a powder. Then, subsequent dispersion or suspension in an aqueous or organic solvent and the addition of the dispersant B or D are necessary before the treatment with ultrasound or bead-mill grinding.

The coarse-scale or nanoscale, coated, de-agglomerated and if necessary functionalized magnesium hydroxide particles obtained after bead-mill grinding or ultrasound treatment are added in an amount of 0.5 to 70 wt.-% with reference to the total weight of the finished, filled polymer (cured mass or polymer dispersion formed into a film).

In this connection, the magnesium hydroxide particles mixed into the curable mass preferably have an average particle size of <2000 nm, such as ≦500 nm, for example ≦200 nm, particularly a nanoscale particle size of ≦100 nm, such as less than 50 nm.

In particular, a curable mass is understood to be a composition that forms a polymer material after polymerization. Preferred curable masses are two-component systems that are produced from a resin component and a hardener component.

Examples that can be are epoxies, unsaturated polyesters, methyl methacrylates and methyl acrylates, acrylates, melamines as well as urethane resins, in order to make available polymer materials—containing polymers on the basis of epoxy resins, unsaturated polyester resins, polymethyl (meth)acrylates or poly(meth)acrylates, melamine resins and polyurethanes.

In another aspect, the present invention is directed at a method for the production of these cured polymer materials, comprising the steps
a) making available coarse-scale and/or nanoscale, precoated magnesium hydroxide particles in dried form,
b) dispersing or suspending the magnesium hydroxide particles in an organic solvent,
c1) bead-mill grinding the suspension or dispersion in the presence of a dispersant D, or alternatively,
c2) treating the suspension or dispersion with ultrasound in the presence of a D,
d1) mixing the suspension or dispersion obtained in step c1), containing de-agglomerated, coarse-scale and/or nanoscale, simply or multiply coated and preferably functionalized magnesium hydroxide particles with a component of a curable mass,
d2) mixing the suspension or dispersion obtained in step c2), containing de-agglomerated, coarse-scale and/or nanoscale, multiply coated and preferably functionalized magnesium hydroxide particles with a component of a curable mass,
e) adding a resin and/or hardener to the mixture from step d1) or d2), whereby the addition of the resin and/or hardener can take place at the same time as the addition of the dispersion/suspension or ahead of that, and
f) curing the curable mass obtained in step d) or e), respectively.

The magnesium hydroxide particle dispersions that were produced according to method step c1) or c2) demonstrate a solids content of 20-70 wt.-% of magnesium hydroxide.

In another aspect, the present invention relates to the curable masses that can be obtained with the method according to the invention, whereby the curable mass contains at least one component with de-agglomerated, coarse-scale and/or nanoscale, simply or multiply coated magnesium hydroxide particles. Preferably, these curable masses are for the production of polymer materials containing epoxy resins, unsaturated polyester resins, polymethyl (meth)acrylates or poly(meth)acrylates, melamine resins or polyurethanes.

In a preferred embodiment, the polymer materials according to the invention are duroplastics or thermoplastics.

In another aspect, the present invention is directed at composite materials containing a curable mass or a polymer material according to the present invention, as well as a reinforcing agent. This composite material is, for example, one that contains duroplastics or thermoplastics that can be obtained according to the invention, or other polymer materials from epoxy resins, unsaturated polyester resins, polymethyl (meth)acrylates or poly(meth)acrylates, melamine resins or polyurethanes. In this connection, reinforcement elements that can be used are those that can be embedded into the polymer matrix, like fibers of glass fibers, carbon fibers, or aramide fibers. These can also be laminates, where fibers or a woven fabric in a polymer matrix are joined together in individual layers.

The production of the composite takes place according to known methods, for example by means of wet lamination, infusion, or by way of prepregs.

The polymer materials according to the invention, like the duroplastics or thermoplastics, or the composite material according to the invention, can be used as light construction material, particularly in ship construction, in wind power plants, for pipe construction, in aircraft construction, in vehicle construction, etc. In this connection, the materials and composites obtained are characterized by improved mechanical properties, particularly by increased elongation to fracture and impact bending resistance, as well as an increase in the modulus of elasticity. Furthermore, these polymer materials and composites can be cost-advantageously produced on a large technical scale, from an economic point of view.

Flame protection agents that contain the nanoscale filled polymer materials according to the invention are superior, because of their mechanical properties, to flame protection agents that contain coarse particles on the μm scale. In particular, also because of the water of crystallization that is contained in the nanoparticles, this water can be given off particularly quickly in case of a fire, because of the large surface area. Thus, cooling of the polymer can take place rapidly, and subsequently, a protective oxide layer can be formed. As a result, excellent fire protection classes can be achieved. In particular, large amounts of fillers can be worked into the polymers, such as filler contents of at least 50 wt.-%, which would otherwise cause the plastic to become brittle and to have a low impact resistance and low elongation to tear values.

In addition, it is possible to work aqueous magnesium hydroxide suspensions or dispersions that can be obtained by means of the methods described, in situ precipitation or ultrasound treatment or bead-mill grinding, into aqueous polymer dispersions. In this connection, adhesive dispersions on the basis of polyvinyl acetates, polyacrylates, and polyurethanes, as well as mixtures of them, can be involved.

Curable masses that contain nanoscale particles, particularly particles on the basis of silicon dioxide or aluminum trioxide, have been known for a long time. For example, such compositions are described in the applications EP 1 179 575, WO 00/35599, WO 99/52964, WO 99/54412, WO 99/52964, DE 197 26 829 or DE 195 40 623. They serve for the production of highly scratch-resistant coatings.

Furthermore, nanoparticles containing transparent varnish binders are known from the European patent application EP 0 943 664, which, with reference to varnish solids, contain 0.5 to 25 wt.-% of primary nanoscale particles worked in as a solid, and are produced by means of nozzle jet dispersion of the nanoscale particles in the binder. By means of simply working in the nanoscale particles, the scratch-resistance of the cured masses produced from the cured varnish binders is increased.

Until now, the nanoparticles were worked into the curable masses as dried or ground powders. However, despite intensive mixing, for example by means of a dissolver or an Ultraturrax, complete de-agglomeration of the agglomerates present in the powder could not be achieved. The polymer materials obtained after polymerization therefore demonstrated agglomerated nanoparticles in the micrometer range. Accordingly, the desired mechanical improvements were not achieved; instead, the mechanical properties of these materials were similar to those with coarse-scale fillers in the micrometer range. This agglomerate formation has the result, just as in the case of the coarse fillers, that the material becomes brittle: this is characterized by a low impact resistance and a low elongation to fracture.

Since it is not nanoscale dried powder, but rather a nanoscale suspension or dispersion, in which the particles are already present in de-agglomerated, coated and if necessary functionalized form, that is mixed into the curable mass as a starting substance, this agglomerate formation, i.e. non-dissolution of the agglomerates is avoided.

For example, bead-mill grinding of magnesium hydroxide particles in n-Butanol as the solvent and a polyether carboxylate, such as Melpers 0030® (BASF) as dispersant D, is carried out. After the bead-mill grinding, a nanoscale, de-agglomerated, coated and functionalized magnesium hydroxide dispersion is obtained, having a solids content of approximately 50 wt.-%, for example, with reference to the solids content of Mg(OH)₂. The dispersant D that is used is coordinated to the epoxy, in terms of polarity. In this way, the dispersion can be combined with a bis-A-epoxy resin, such as Araldit LY 556, Huntsman, and subsequently homogenized by means of simple stirring. The solvent, here n-butanol, can subsequently be drawn off by means of a rotation evaporator, for example. What remains is a resin filled with de-agglomerated, coated and preferably functionalized nanoparticles of magnesium hydroxide. In this way, what are called “master batches” can be produced, which, as “concentrates,” have a high degree of inorganic filling (above 50 wt.-%), and can easily be diluted down with the pure resin.

Bead-mill grinding can also be carried out in methyl ethyl ketone as an organic solvent, with an epoxy-functionalized silane, such as Glymo® (Degussa) as dispersant D. For this purpose, the coarse-scale and/or nanoscale, precoated magnesium hydroxide particles that are made available are suspended or dispersed in methyl ethyl ketone in dried form. The dispersant D is added to the solvent in advance or during dispersion. After grinding, a nanoscale, de-agglomerated, coated and functionalized magnesium hydroxide dispersion is obtained, with a solids content of approximately 50 wt.-%, for example. The dispersant D used is coordinated with the epoxy resin, in terms of polarity. In this way, this dispersion can be combined with a bis-A-epoxy resin and subsequently homogenized by means of simple stirring. The solvent is drawn off by means of a rotation evaporator, if necessary. All that remains is a resin filled with de-agglomerated, coated and functionalized nanoparticles of magnesium hydroxide.

The particles are coated with Glymo® and thus carry reactive epoxy groups on their surface, just like the resin. These reactive epoxy groups of the Glymo® can rapidly react with the amine or anhydride groups of the hardener. Thus, the magnesium hydroxide particles are covalently bonded to the polymer matrix by way of the additive, and this represents a significant advantage as compared with Melpers 0030®, which is used in the state of the art.

Surprisingly, it was observed that the magnesium hydroxide particles coated with Melpers 0030®, which carry hydroxy groups as a result of the additive, do not react with the epoxy resin and do not cure it.

It is also possible to work the particles into an N-containing hardener, whether aromatic, aliphatic or cyclic, or into mixtures of them. These N-containing hardeners can have primary or secondary amine groups, polyamines or amino compounds. Bead-mill grinding of magnesium hydroxide particles in ethanol as a solvent and an amino-functionalized silane, such as Ameo® from Degussa, as a dispersant, will be mentioned as an example. The dispersion obtained according to the invention, with magnesium hydroxide particles, contains these at a solids content of about 50 wt.-%. The dispersant D that is used is coordinated with the hardener, in terms of polarity, in other words it has a similar polarity. In this way, this dispersion can be combined with the hardener, such as an isophorone diamine or dicyanodiamine, and subsequently homogenized by means of simple stirring. If necessary, the solvent, such as ethanol, is drawn off by means of a rotation evaporator. What remains is a hardener filled with de-agglomerated, coated and functionalized nanoparticles of magnesium hydroxide. This hardener can then be processed further with the resin, in order to obtain duroplastic, polymer materials according to the invention.

These introduction methods that have been described, in which the nanoparticles are present in the master batch in de-agglomerated form and, if necessary, in functionalized form, can also be transferred to other curable masses. However, it should be noted that for one thing, the polarity of the dispersant B or dispersant D must be matched with that of the target polymer, and, for another, that the functional reactive groups of the additive must be coordinated with the target polymer. Thus, for example, Ken-React CP-03® (Kenrich Petrochemicals), Solplus C800® (Lubrizol) or VTMO® (Degussa) are suitable as dispersant D for being worked into unsaturated polyester resins, which usually contain a high styrene proportion and are cured radically. These aforementioned additives have double bonds that are polymerized into the polymer matrix during radical curing, and have a similar polarity, in comparison with unsaturated polyester resins.

In the case of the use of polyols, such as for the production of polyurethanes, additives should be used that have terminal OH groups with a polarity similar to that of polyols. For example, here Disperbyk 102® (Byk-Chemie) can be used as dispersant D; it contains OH groups as a functionality in the molecule.

By means of the aforementioned methods, so-called master batches can be produced, which, as “concentrates” (filled resin or hardener concentrates) have a high degree of inorganic filling, at greater than 50 wt.-% magnesium hydroxide) and can be diluted down with pure resin, in simple manner.

In another embodiment of the method according to the invention, a so-called reactive thinner is used as a solvent for bead-mill grinding or ultrasound treatment. This reactive thinner participates in the curing reaction and is installed in the molecular polymer network. Reactive thinners are known in the state of the art; they are usually low-viscosity glycidyl ethers of monofunctional or difunctional aliphatic alcohols or alkyl phenols. The amounts added in practice generally lie between 5 wt.-% and 30 wt.-% with reference to the proportion of the base resin, and are determined by the adjustment of the optimum regarding low processing viscosity and sufficient final properties.

In this connection, the reactive thinners can simultaneously assume the function of an organic solvent. Suitable reactive thinners are diglycidyls or diamines, for example hexane diglycidyl ether, Rutapox-EPD HD, from the Hexion company. Highly filled “nano-pastes” with degrees of filling of 50 to 80 wt.-%, for example, can be generated, which can then be diluted down to the desired concentration at the consumer's own location.

But not only suspensions or dispersions in organic solvents, but also in aqueous solvents can be processed. Thus it is possible to work an aqueous, nanoscale, coated, de-agglomerated magnesium hydroxide dispersion into an aqueous plastic dispersion. This plastic dispersion can be one on a polyacrylate or polyvinyl acetate or urethane basis, or mixtures of them. For this purpose, an aqueous, nanoscale, coated de-agglomerated magnesium hydroxide dispersion with Melpers 0030® as the dispersant B, for example, is added in to the plastic dispersion in a desired concentration.

In general, the compatibility of the plastic dispersion with the magnesium hydroxide suspension or dispersion is characterized in that neither coagulate formation nor a change in the viscosity occurs. In thin layers, optical transparency should be maintained after the plastic dispersion and the magnesium hydroxide dispersion are combined. In most cases visible by means of a red gleam. If one allows the dispersions to form a film, then transparent polymer films form, filled with nanoscale, coated, de-agglomerated and homogeneously distributed magnesium hydroxide.

In the following, the invention will be explained in greater detail using examples. These examples serve for a further explanation of the invention, without restricting it to them.

### EXAMPLES

### Example 1

A powdered, coarse-scale or nanoscale magnesium hydroxide is used as an educt, preferably in precoated form. The dried magnesium hydroxide was preground using a ring screen mill (200 μm screen). After grinding, the powder had an average particle size of 6.85 μm (determined using Beckmann Coulter LS 13320, in accordance with manufacturer's instructions).

The preground magnesium hydroxide that was obtained was processed while stirring with a laboratory dissolver (IKA, Germany) and with the addition of methyl ethyl ketone, to produce an organic suspension. In order to lower the viscosity, a sterically stabilizing dispersant D was added, which also prevents the subsequent re-agglomeration of broken-up magnesium hydroxide particles. The dispersant, Dynasylan® Glymo, was added in an amount of 3 wt.-% with reference to the solids content of magnesium hydroxide. After a homogeneous suspension having a solids content of 20 wt.-% magnesium hydroxide had been produced in the dissolver, this suspension was ground further using a stirrer ball mill AH 90, Hosokawa Alpine AG. The progression of the grinding process was followed up by determining the particle size distribution by means of the Beckmann Coulter LS 13320. An organic, coated, de-agglomerated and functionalized magnesium hydroxide dispersion having an average particle diameter of 150 nm was obtained.

Subsequently, this dispersion was combined with a bisphenol-A resin—e.g. Huntsmann Araldite LY 556—and homogenized using a laboratory stirrer. The solvent, methyl ethyl ketone, was removed by means of a rotation evaporator, under vacuum (40 mbar), at 45° C.

What remained was an epoxy resin filled with coated and de-agglomerated and functionalized magnesium hydroxide particles, which could be diluted down as desired, using pure resin.

### Example 2

A powdered, coarse-scale or nanoscale magnesium hydroxide is used as an educt, preferably in precoated form.

The dried magnesium hydroxide was preground using a ring screen mill (200 μm screen). After grinding, the powder had an average particle size of 6.85 μm (determined using Beckmann Coulter LS 13320, in accordance with manufacturer's instructions).

The preground magnesium hydroxide that was obtained was processed while stirring with a laboratory dissolver (IKA, Germany) and with the addition of isopropanol, to produce an organic suspension. In order to lower the viscosity, a sterically stabilizing dispersant D was added, which also prevents the subsequent re-agglomeration of broken-up magnesium hydroxide particles. The dispersant, Dynasylan® Ameo, was added in an amount of 3 wt.-% with reference to the solids content of magnesium hydroxide. After a homogeneous suspension having a solids content of 20 wt.-% magnesium hydroxide had been produced in the dissolver, this suspension was ground further using a stirrer ball mill AH 90, Hosokawa Alpine AG. The progression of the grinding process was followed up by determining the particle size distribution by means of the Beckmann Coulter LS 13320. An organic, coated, de-agglomerated and functionalized magnesium hydroxide dispersion having an average particle diameter of 145 nm was obtained. Subsequently, this dispersion was combined with an amine hardener—e.g. isophorone diamine—and homogenized using a laboratory stirrer. The solvent, isopropanol, was removed by means of a rotation evaporator, under vacuum (40 mbar), at 45° C.

What remained was a hardener filled with coated and de-agglomerated and functionalized magnesium hydroxide particles, which could be diluted down as desired, using the pure substance.

### Example 3

A powdered, coarse-scale or nanoscale magnesium hydroxide was used as an educt, preferably in precoated form.

The dried magnesium hydroxide was preground using a ring screen mill (200 μm screen). After grinding, the powder had an average particle size of 6.85 μm (determined using Beckmann Coulter LS 13320, in accordance with manufacturer's instructions).

The preground magnesium hydroxide that was obtained was processed while stirring with a laboratory dissolver (IKA, Germany) and with the addition of water, to produce an aqueous suspension. In order to lower the viscosity, a sterically stabilizing dispersant B was added, which also prevents the subsequent re-agglomeration of broken-up magnesium hydroxide particles. The dispersant, Melpers® 0030, was added in an amount of 8.5 wt.-% with reference to the solids content of magnesium hydroxide. After a homogeneous suspension having a solids content of 30 wt.-% magnesium hydroxide had been produced in the dissolver, this suspension was ground further using a stirrer ball mill AH 90, Hosokawa Alpine AG. The progression of the grinding process was followed up by determining the particle size distribution by means of the Beckmann Coulter LS 13320. An organic, coated, de-agglomerated and functionalized magnesium hydroxide dispersion having an average particle diameter of 110 nm was obtained.

Subsequently, this dispersion was combined with an aqueous adhesive dispersion—e.g. BASF dispersion Luphen DS 3548—and homogenized using a laboratory stirrer. Subsequently, it was possible to apply the storage-stable, filled PU adhesive dispersion.

### Example 4

A powdered, coarse-scale or nanoscale magnesium hydroxide is used as an educt, in precoated form.

The dried magnesium hydroxide was preground using a ring screen mill (200 μm screen). After grinding, the powder had an average particle size of 6.85 μm (determined using Beckmann Coulter LS 13320, in accordance with manufacturer's instructions).

The preground magnesium hydroxide that was obtained was processed while stirring with a laboratory dissolver (IKA, Germany) and with the addition of methyl ethyl ketone, to produce an organic suspension. In order to lower the viscosity, a sterically stabilizing dispersant D was added, which also prevents the subsequent re-agglomeration of broken-up magnesium hydroxide particles. The dispersant, Dynasylan® Glymo, was added in an amount of 3 wt.-% with reference to the solids content of magnesium hydroxide. After a homogeneous suspension having a solids content of 20 wt.-% magnesium hydroxide had been produced in the dissolver, this suspension was subsequently pumped in circulation through an ultrasound cell, in which an ultrasound probe (UIP 1000, Hielscher, Germany) was immersed. After approximately half an hour, proceeding from 2 liters of a 50% suspension of educt, a coated, de-agglomerated and functionalized magnesium hydroxide dispersion was obtained, which demonstrated a narrow particle size distribution and an average particle size of 137 nm.

Subsequently, this dispersion was combined with a bisphenol-A resin—e.g. Huntsmann Araldite LY 556—and homogenized using a laboratory stirrer. The solvent, methyl ethyl ketone, was removed by means of a rotation evaporator, under vacuum (40 mbar), at 45° C.

What remained was an epoxy resin filled with coated and de-agglomerated and functionalized magnesium hydroxide particles, which could be diluted down as desired, using pure resin.

### Example 5

A powdered, coarse-scale or nanoscale magnesium hydroxide is used as an educt, in precoated form.

The dried magnesium hydroxide was preground using a ring screen mill (200 μm screen). After grinding, the powder had an average particle size of 6.85 μm (determined using Beckmann Coulter LS 13320, in accordance with manufacturer's instructions).

The preground magnesium hydroxide that was obtained was processed while stirring with a laboratory dissolver (IKA, Germany) and with the addition of isopropanol, to produce an organic suspension. In order to lower the viscosity, a sterically stabilizing dispersant D was added, which also prevents the subsequent re-agglomeration of broken-up magnesium hydroxide particles. The dispersant, Dynasylan® Ameo, was added in an amount of 3 wt.-% with reference to the solids content of magnesium hydroxide. After a homogeneous suspension having a solids content of 20 wt.-% magnesium hydroxide had been produced in the dissolver, this suspension was subsequently pumped in circulation through an ultrasound cell, in which an ultrasound probe (UIP 1000, Hielscher, Germany) was immersed. After approximately half an hour, proceeding from 2 liters of a 50% suspension of educt, a coated, de-agglomerated and functionalized magnesium hydroxide dispersion was obtained, which demonstrated a narrow particle size distribution and an average particle size of 148 nm.

Subsequently, this dispersion was combined with an amine hardener—e.g. isophorone diamine—and homogenized using a laboratory stirrer. The solvent, isopropanol, was removed by means of a rotation evaporator, under vacuum (40 mbar), at 45° C.

What remained was a hardener filled with coated and de-agglomerated and functionalized magnesium hydroxide particles, which could be diluted down as desired, using the pure substance.

### Example 6

A powdered, coarse-scale or nanoscale magnesium hydroxide was used as an educt, in precoated form.

The dried magnesium hydroxide was preground using a ring screen mill (200 μm screen). After grinding, the powder had an average particle size of 6.85 μm (determined using Beckmann Coulter LS 13320, in accordance with manufacturer's instructions).

The preground magnesium hydroxide that was obtained was processed while stirring with a laboratory dissolver (IKA, Germany) and with the addition of water, to produce an aqueous suspension. In order to lower the viscosity, a sterically stabilizing dispersant B was added, which also prevents the subsequent re-agglomeration of broken-up magnesium hydroxide particles. The dispersant, Melpers® 0030, was added in an amount of 8.5 wt.-% with reference to the solids content of magnesium hydroxide. After a homogeneous suspension having a solids content of 20 wt.-% magnesium hydroxide had been produced in the dissolver, this suspension was subsequently pumped in circulation through an ultrasound cell, in which an ultrasound probe (UIP 1000, Hielscher, Germany) was immersed. After approximately half an hour, proceeding from 2 liters of a 50% suspension of educt, a coated, de-agglomerated and functionalized magnesium hydroxide dispersion was obtained, which demonstrated a narrow particle size distribution and an average particle size of 95 nm.

Subsequently, this dispersion was combined with an aqueous adhesive dispersion—e.g. BASF dispersion Luphen DS 3548—and homogenized using a laboratory stirrer. Subsequently, it was possible to apply the storage-stable, filled PU adhesive dispersion.

1. Method for the production of curable masses, containing coarse-scale and/or nanoscale, coated, de-agglomerated magnesium hydroxide particles, comprising the steps
a) making available coarse-scale and/or nanoscale, non-coated or precoated magnesium hydroxide particles in dried form,
b) dispersing or suspending the magnesium hydroxide particles in an organic solvent,
c1) bead-mill grinding of the suspension or dispersion in the presence of a dispersant D, or alternatively,
c2) treating the suspension or dispersion with ultrasound in the presence of a dispersant D,
d1) mixing the dispersion obtained in step c1), containing de-agglomerated, coarse-scale and/or nanoscale, simply or multiply coated magnesium hydroxide particles with a component of a curable mass, or alternatively,
d2) mixing the dispersion obtained in step c2), containing de-agglomerated, coarse-scale and/or nanoscale, multiply coated magnesium hydroxide particles with a component of a curable mass.

2. Method for the production of filled polymer dispersions, containing coarse-scale and/or nanoscale, coated, de-agglomerated magnesium hydroxide particles, comprising the steps
a) making available coarse-scale or nanoscale, precoated magnesium hydroxide particles as a suspension or dispersion in an aqueous solvent containing dispersant B or in dried form;
b) if necessary, dispersing or suspending the magnesium hydroxide in an aqueous solvent, using dried powder,
c1) bead-mill grinding of the suspension or dispersion in the presence of a dispersant B, or alternatively,
c2) treating the suspension or dispersion with ultrasound in the presence of dispersant B,
d1) mixing the dispersion obtained in step c1), containing de-agglomerated, coarse-scale and/or nanoscale, simply or multiply coated magnesium hydroxide particles with an aqueous polymer dispersion, or alternatively,
d2) mixing the dispersion obtained in step c2), containing de-agglomerated, coarse-scale and/or nanoscale, multiply coated magnesium hydroxide particles with an aqueous polymer dispersion,
e) forming the polymer from the polymer dispersion obtained in this way, in step d1) and d2).

3. Method for the production of a cured mass, comprising the steps
a) making available coarse-scale and/or nanoscale, non-coated or precoated magnesium hydroxide particles in dried form,
b) dispersing or suspending the magnesium hydroxide particles in an organic solvent,
c1) bead-mill grinding the suspension or dispersion in the presence of a dispersant D, or alternatively,
c2) treating the suspension or dispersion with ultrasound in the presence of a dispersant D,
d1) mixing the dispersion obtained in step c1), containing de-agglomerated, coarse-scale and/or nanoscale, simply or multiply coated magnesium hydroxide particles with a component of a curable mass, or alternatively,
d2) mixing the dispersion obtained in step c2), containing de-agglomerated, coarse-scale and/or nanoscale, multiply coated magnesium hydroxide particles with a component of a curable mass,
e) adding a resin and/or hardener to the mixture from step d1) or d2), whereby the addition of the resin and/or hardener can take place at the same time as the addition of the dispersion/suspension or ahead of that, and
f) curing the curable mass by means of adding a suitable component.

4. Method according to claim 1, whereby the magnesium hydroxide particles in the suspension or dispersion obtained according to step c1) or step c2) are contained at a solids content of 20 to 70 wt.-% magnesium hydroxide.

5. Method according to claim 1, whereby the amount of dispersant D or dispersant B in step c1) or c2) amounts to 0.1 to 20 wt.-% with reference to the solids content of magnesium hydroxide particles.

6. Method according to claim 1, whereby the magnesium hydroxide particles according to step c1) or c2) have an average particle size of ≦500 nm, preferably ≦100 nm.

7. Method according to claim 1, whereby the dispersant D or dispersant B is a functionalized dispersant.

8. Method according to claim 1, containing furthermore the step of removal of the organic solvent from the curable mass.

9. Method according to claim 1, comprising the addition of a reactive thinner to the curable mass.

10. Method according to claim 1, whereby the organic solvent is a reactive thinner.

11. Method according to claim 2, whereby the coarse-scale and/or nanoscale, coated and de-agglomerated magnesium hydroxide particles are contained in an amount of 0.5 to 70 wt.-%, with reference to the total weight of the cured mass or the polymer dispersion that has been formed into a film, in this dispersion.

12. Method according to claim 1, whereby the coarse-scale and/or nanoscale, coated and de-agglomerated magnesium hydroxide particles are in an amount of 20 to 95 wt.-% with reference to the total weight of the curable masses.

13. Method according to claim 1, whereby the components in the curable mass are selected from among precursors for epoxy resins, melamine resins, unsaturated polyester resins, polymethyl (meth)acrylates or poly(meth)acrylates or polyurethanes.

14. Curable mass that can be obtained at least according to claim 1.

15. Curable mass, particularly filled duroplastic or thermoplastic, which can be obtained according to a method according to claim 3.

16. Composite material containing a curable mass or cured mass according to claim 1, furthermore containing a reinforcement agent.

17. Composite material according to claim 16, whereby the reinforcement agent is carbon fiber, aramide fiber or glass fiber.

18. Aqueous filled polymer dispersion, containing coarse-scale and/or nanoscale, coated magnesium hydroxide particles, which can be obtained according to methods for production according to claim 2.

19. Aqueous filled polymer dispersion, containing coarse-scale and/or nanoscale, coated magnesium hydroxide particles, which can be obtained according to methods of in situ precipitation, whereby in a step i), a magnesium salt solution is brought into contact with ii) an alkali hydroxide solution, forming a reaction mixture for the precipitation of coated magnesium hydroxide particles, wherein
at least one of the following additives A, B and C is contained in at least one of the solutions i) or ii), or
when i) and ii) are brought into contact, at least one of the following additives A, B and C is simultaneously brought into contact with the reaction mixture that results from i) and ii), whereby the additives are
a growth inhibitor A,
a dispersant B,
an aqueous stearate solution C or mixtures thereof.

20. Master batches, produced by means of the stated method according to claim 1, have a filler content of 20 to 95 wt.-% magnesium hydroxide.
